(19) United States
(12) Patent Application Publication
(10) Pub. No.: US 2019/0152405 A1
(43) Pub. Date: May 23, 2019

(54) KeyStor – Lock box assembly comprised of license plate holder and secured compartment for attachment to vehicle and spare key storage.

(71) Applicant: Jeffrey Allen Mohr, Dothan, AL (US)

(72) Inventor: Jeffrey Allen Mohr, Dothan, AL (US)

(21) Appl. No.: 15/817,249

(22) Filed: Nov. 19, 2017

(51) Int. Cl. B60R 9/06; E05B 19/00

(52) U.S. Cl. CPC B60R 9/065; E05B 37/02; E05B 19/0005

(57) ABSTRACT

Lock box assembly comprised of license plate holder and secured compartment for attachment to vehicle and spare key storage. My invention is securely attached to the vehicle in a universally accessible location. The key is securely stored by a lock mechanism whether combination, phone application, digital thumb recognition, or other technology and has light for illumination necessary for all lighting situations. All measurements provided are estimates at this time and may be modified and adjusted as necessary for function and purpose as the finished product is developed and produced.

### CROSS-REFERENCE TO RELATED APPLICATIONS

Corresponding Provisional Application No. 62/430,809

Corresponding Provisional Application Confirmation Number: 1845

### BACKGROUND OF THE INVENTION

### (1) Field of the Invention

The invention pertains to secure storage. More specifically, the invention pertains to spare key storage on a licensed vehicle.

### (2) Description of the Related Art

Over the years my wife and I have locked our keys in the vehicle. The first time it happened we were at a park with our children on a holiday weekend. Between changing diapers and grabbing the necessities, my wife and I overlooked the keys lying on the front seat. Our only solution was to call a locksmith. Over an hour later and a $100 lighter we and our worn out babies were on our way. The next time we experienced a lockout I was working a home health job and left my keys laying on the center console as I prepared my equipment to see the patient. As soon as the door shut I realized what I had done. Rather than call a locksmith, I contacted my wife who came about two hours later when she had a break at work. Cheaper, but lost two hours of my workday which I had to make up later in the week. Fast forward fifteen years later. My wife was taking a regional job where she would be traveling in three states spending much of her time in rural communities. I was worried that she would potentially lock herself out of her vehicle and may or may not be able to reach a locksmith. About this same time my oldest daughter was going away to college about five hours from home. I did like any good dad would do and bought a magnetic hide a key and placed it where no one except us would or could find it. When my daughter returned home from college for the first time, the magnetic key holder had fallen off the vehicle and the spare key was lost. So here we go to the dealer to pay for a new coded spare key. Not wanting the same fate for my wife's key, I researched options for a secure way to store a vehicle spare key. To my surprise, there were no good options. I had a house lock box available and attached it to the tow hook on the back of my wife's SUV. Problem solved. You could not count the number of people that told me that there was something hanging from the back of our SUV. As for my daughter's car, it sat too low to the ground to use a lock box. But this got me thinking, there had to be a better way.

My extensive search for a solution revealed two commercial options. One is attached to the tow hitch and essentially looks and functions like the house lock box we used. The other option requires you to drill a hole in your vehicle's metal for attachment. I wanted something that could be used on any licensed vehicle. It needed to be convenient and accessible in any lighting situation. My goal was to design a lock box that could be attached to the vehicle using existing fasteners and designed so that it was not obvious when driving down the road. One thing all road vehicles have in common is that they are required to have a license plate. The result is “the KeyStor”.

### BRIEF SUMMARY OF THE INVENTION

The KeyStor is intended to assist a person in regaining entry to their vehicle in the event of an unintended lockout, such as locking their keys in their car. Existing spare key holders are attached to the vehicle via magnets or cables. Magnetized holders have been known to fall off the vehicle and cable attached holders cannot be secured in an easily accessible location.

The KeyStor is securely attached to the vehicle in a universally accessible location. The key is securely stored by a combination lock that is illuminated to accommodate any lighting situation.

### BRIEF DESCRIPTION OF THE SEVERAL VIEWS OF THE DRAWING

FIG. 1 is the mounting plate for license plate attachment. It is the outer hinged cover that protects and hides the lock assembly door.

FIG. 2 is the lock assembly door that houses the combination lock and light assembly providing security and accessibility to the key housing.

FIG. 3 is the key housing which is equipped with openings for attachment to vehicle and storage for spare key.

FIG. 4 is the isometric view which shows how all components interact.

FIG. 5 is the notes to fabricator.

### DETAILED DESCRIPTION OF THE INVENTION

As stated above, my invention is intended to assist a person regain entry to their vehicle in the event of an unintended lockout, such as locking their keys in their car. Existing spare key holders are attached to the vehicle via magnets or cables. Magnetized holders have been known to fall off the vehicle and cable attached holders cannot be secured in an easily accessible location. This invention is an improvement on what currently exists. I have been unable to find a secured spare key holder that attaches to vehicles in a conveniently accessible location. The invention claimed here solves this problem.

My invention is securely attached to the vehicle in a universally accessible location. The key is securely stored by a combination lock that is illuminated to accommodate any lighting situation.

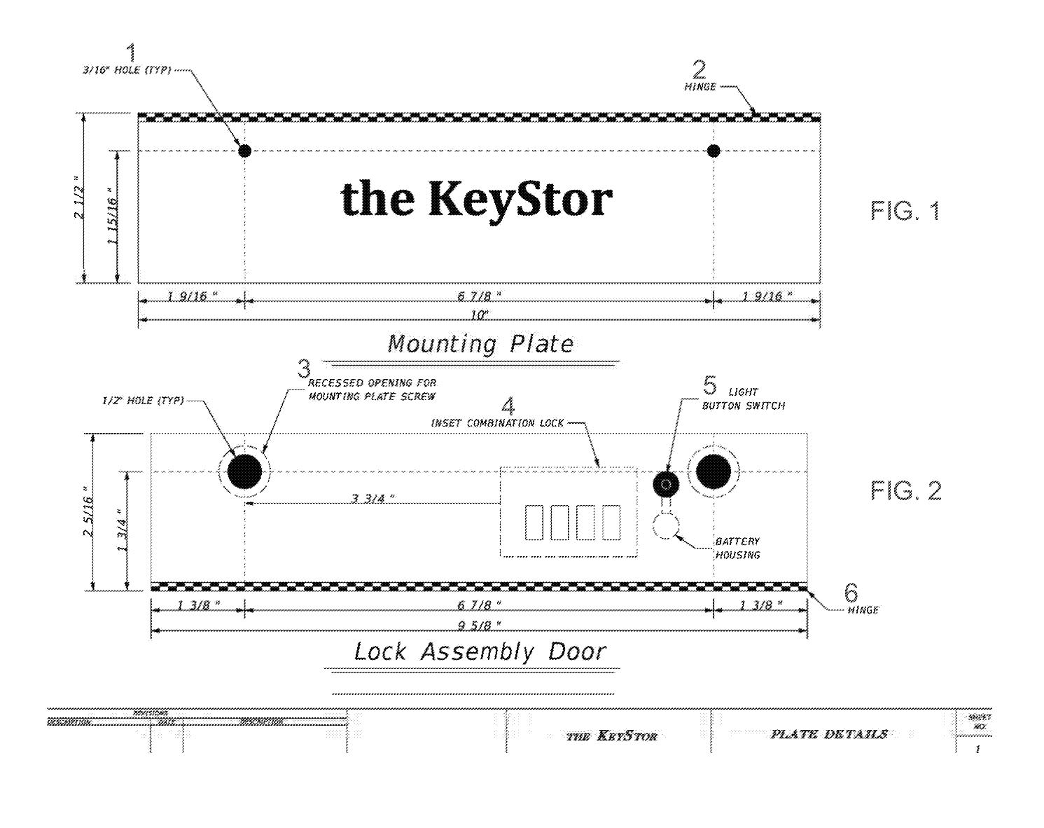

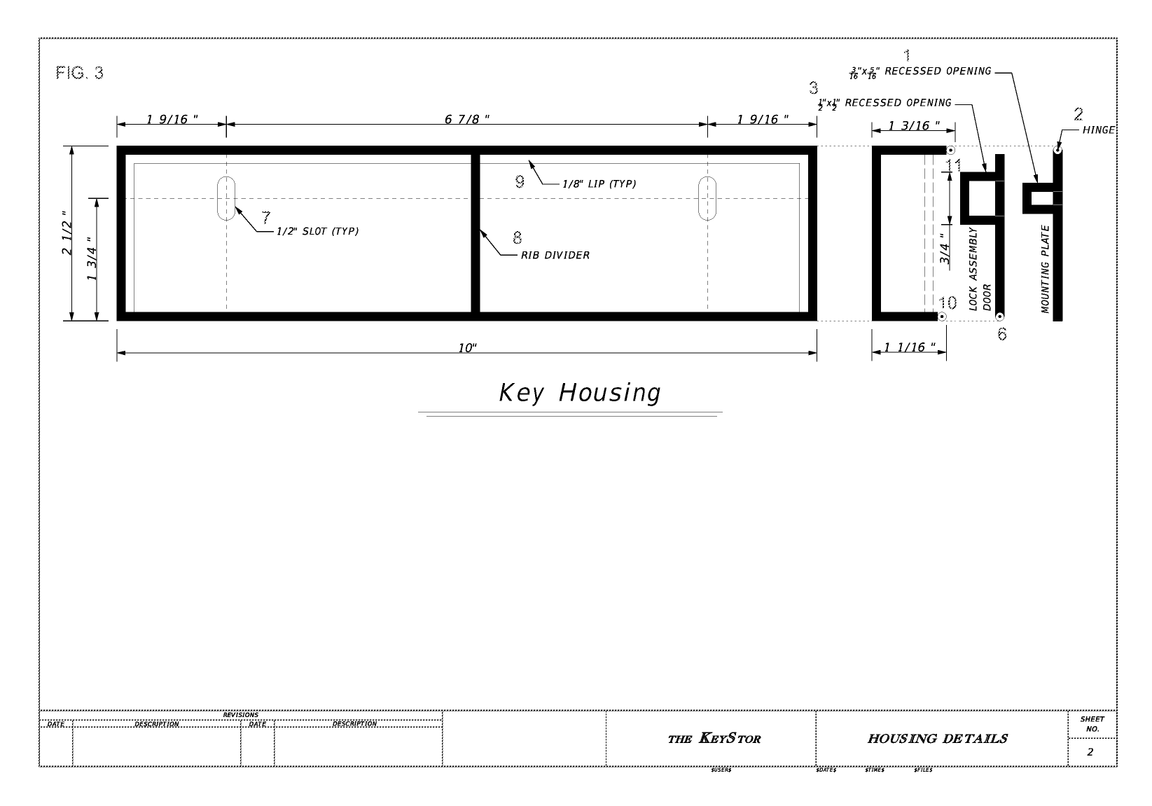

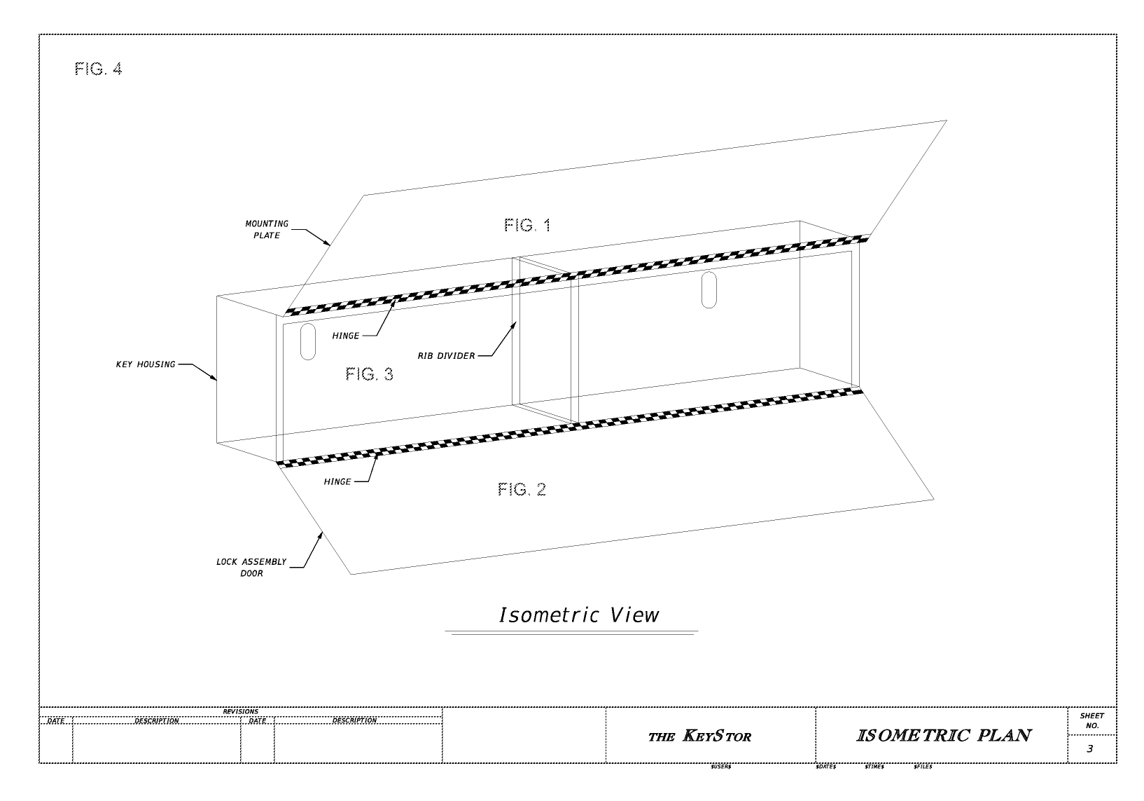

The Version of the Invention Discussed Here Includes:
1. Mounting Plate is the outer hinged license plate holder. Approximately 2½″×10″×⅛″ injected molded plastic hinged (FIG. 1, FIG. 3, 2) at the top. License plate attachment utilizes holes in a recessed opening (FIG. 1, FIG. 2, 1) in mounting plate.
2. Lock Assembly Door is the interior hinged component that houses the combination lock and light assembly providing security and accessibility to the Key Housing. Approximately 2 5/16″×9⅝″×⅛″ injected molded plastic hinged (FIG. 2, FIG. 3, 6) at the bottom. There is a recessed opening (FIG. 2, FIG. 3, 3) for mounting plate screw to go into. There is an opening (FIG. 2, 4) for the inset combination lock light combination to be assembled. The combination lock light combination is still to be engineered for production. A button light switch (FIG. 2, 5) will activate combination lock light for illumination in poor lighting conditions.
3. Key Housing is the box assembly equipped with openings for attachment to vehicle and storage for spare key. Approximately 2½″×10″×1 3/16″ injected molded plastic hinged (FIGS. 3, 10 and 11) at the top bottom. It includes the holes (FIG. 3, 7) to allow attachment to vehicle utilizing existing holes and fasteners that originally attached license plate to vehicle. There is a center rib divider (FIG. 3, 8) to separate storage compartment from combination lock light combination area and to add strength to Key Housing. There is an approximate ⅛″ lip (FIG. 3, 9) that provides seating for Lock Assembly Door (FIG. 2) and possible catch for locking mechanism (FIG. 2, 4) to secure Lock Assembly Door in closed position.
4. Notes to Fabricator list additional components and details of invention that will be needed for desired function and appearance that have not been engineered at the time of patent application. It is anticipated that the detailed description of the invention will be updated at the time of production.

How the Invention Works:

My lock box assembly with license plate holder is a combination lock secured spare key holder and is attached to a vehicle using the receptacles and screws for normal license plate attachment. Once installed to the vehicle, the license plate is attached to the Mounting Plate (FIG. 1). If a person locks themselves out of the vehicle, they go to the back of the vehicle, lift the license plate up via the hinged attachment revealing and illuminating the combination lock. Dial numbers/letters chosen for combination, depress lock release to hinge open cover revealing spare key. This process will also allow access to screws attaching invention to vehicle.

How to Make the Invention:

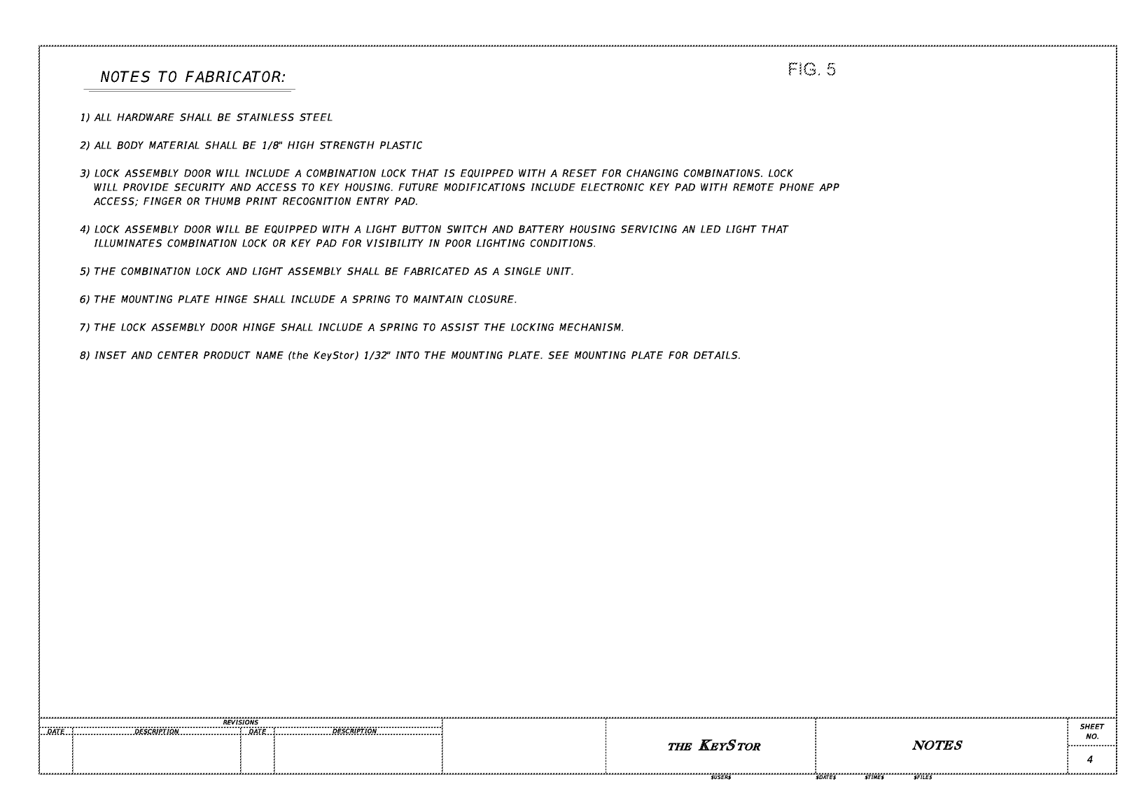

Mounting Plate (FIG. 1), Lock Assembly Door (FIG. 2) and Key Housing (FIG. 3) should be made of high strength injected molded plastics to allow strength necessary for security. The Mounting Plate is designed for license plate attachment and provides cover and protection to the Lock Assembly Door and its components. The Lock Assembly Door is designed to cover storage compartment. It is equipped with a combination lock for security and a light to illuminate numbers/letters when the Mounting Plate is lifted revealing the combination lock. The Key Housing is the box portion of the assembly where the spare key is stored and the combination light combination is housed. Within the Key Housing are the holes for attaching the invention to the vehicle. FIG. 4 is the isometric view which shows how all components interact. All elements are necessary to operate as intended securing invention to vehicle and holding spare key, usable in all lighting situations and to hold license plate as required by law.

How to Use the Invention:

If a person has locked themselves out of their vehicle or lost their keys, they would lift license plate up revealing secured storage. Enter combination, push release lever hinging lock cover open to access spare key.

1. A lock box assembly comprising a Key Housing allowing storage of spare key comprising holes to allow attachment to vehicle utilizing existing holes and fasteners that originally attach license plate to vehicle and comprising a center rib divider to separate key storage compartment from space needed to allow lock light combination which is part of the lock assembly door to be recessed and to add strength to Key Housing.

2. A lock box assembly comprising a hinged Lock Assembly Door designed to cover storage compartment equipped with a combination lock for security and a light to illuminate numbers/letters in low lighting environments attaching to the Key Housing component that provides storage of spare key and space needed to house the combination lock and light assembly providing security and accessibility to the Key Housing discussed in claim 1.

3. A lock box assembly comprising a hinged outer Mounting Plate attached to the Key Housing discussed in claim 1 that provides protection for the Lock Assembly Door discussed in claim 2 and attachment of license plate utilizing holes in a recessed opening in Mounting Plate.
